(19) United States
(12) Patent Application Publication
(10) Pub. No.: US 2007/0082190 A1
(43) Pub. Date: Apr. 12, 2007

(54) Insulation material

(76) Inventors: Klaus Endres, Homburg (DE); Helmut Schmidt, Saarbruecken-Guedingen (DE); Bernd Reinhard, Merzig-Brotdorf (DE); Stefan Goedicke, Neunkirchen (DE)

Correspondence Address: GREENBLUM & BERNSTEIN, P.L.C., 1950 ROLAND CLARKE PLACE, RESTON, VA, 20191, US

(21) Appl. No.: 10/580,538

(22) PCT Filed: Nov. 26, 2004
(86) PCT No.: PCT/EP04/13448

§ 371 Date: May 25, 2006

(30) Foreign Application Priority Data
Nov. 28, 2003 (DE) 10355668.0

(51) Int. Cl. E04B 1/74; C04B 38/00

(52) U.S. Cl. 428/312.2; 252/62; 501/80; 428/312.4; 428/312.8; 264/49

(57) ABSTRACT

An insulation material comprising an inorganic, porous matrix, a process for producing it and its use are described. The moldings and coatings obtained therefrom display excellent insulation against heat and cold and can be used over a wide temperature range.

The present invention relates to an insulation material comprising an inorganic, porous matrix and processes for producing it and its use.

Inorganic insulation materials frequently suffer from the problem that they have various inadequacies. Thus, for example, shapeability to produce the desired geometry is a problem in the case of insulation materials which can be used in a relatively wide temperature range, so that production is expensive or has to be matched to a simpler geometry. In general, the insulation efficiency is also significantly lower than that of typical organic insulation materials such as polymer foam (e.g. Styropor®).

In the case of some insulation materials according to the prior art, use is made of, inter alia, glass, e.g. in the form of glass foams. Since conventional glass generally softens or melts at from about 500 to 600° C., at least at 700° C., this temperature limit can usually not be exceeded for conventional insulation materials comprising glass. In addition, percolating glass struts have a much lower insulating effect than do porous compounds. Machinability and subsequent shaping is generally not possible, so that only simple geometries can be obtained. However, there is also a need for inexpensive, highly insulating insulation materials which can also be used at higher temperatures.

It was therefore an object of the invention to provide readily shapeable insulation materials which have a high heat resistance combined with a high insulating effect and can also be used at temperatures of more than 500° C. or more than 700° C. Furthermore, the insulation materials and the process used should be economical and make a complex geometry possible.

The object of the invention has been achieved by an insulation material which comprises an inorganic, porous matrix in which additional pores are formed by means of a pore former and is obtainable from a composition comprising a binder which forms the porous matrix and a pore-forming filler. The binder comprises a sol which contains nanoparticles and/or another unmodified or organically modified inorganic precursor which forms a porous structure. The sol can be stabilized by conventional methods, e.g. by setting a suitable zeta (ζ) potential. Another form of the stabilization of the sol is surface modification of the sol particles, e.g. by means of one or more silanes of the general formula
RₙSiX₄₋ₙ (I)
where the groups X are identical or different and are hydrolyzable groups or hydroxyl groups, the radicals R are identical or different and are each alkyl, alkenyl, alkynyl, aryl, aralkyl or alkylaryl and n is 0, 1, 2 or 3. It is also possible to use other surface modifiers as long as they have a sufficient binding strength to the nanoparticle surface, e.g. β-diketones, organic acids, amino acids or proteins. In addition, further organic components such as oligomers or the like can be mixed into the binder to obtain an advantageous rheology. It has been found to be advantageous to add silanes of the type SiX₄ (X as defined above) and alkoxides of the type MX_{b}, where b is the valence of the central atom and M can be as defined below.

To achieve excellent insulating action, a solid which is able to produce a further pore structure is added to the binder. For this purpose, it is possible to employ, for example, hollow glass microspheres or other pore-forming solids which, for example, decompose or volatilize on heating and thus leave pores behind, e.g. volatile salts such as NH₄Cl or organic powders such as wood flour, flour and small polymer spheres.

Surprisingly, the combination of the abovementioned binder and the pore-forming filler forms a readily moldable, pourable composition which may be able to cure even at room temperature and may be able to be converted into a purely inorganic material at relatively high temperatures by burning out organic constituents, if present.

It is suitable both for coatings and for moldings. The thermal stability can even be increased by the use of refractory materials. The components used themselves are relatively inexpensive and make it possible to use simple and inexpensive methods of shaping.

The present invention accordingly provides an insulation material which comprises an inorganic, porous matrix and is obtainable by shaping a composition comprising a) a sol comprising nanoparticles and/or polycondensates or precursors thereof as binder and b) solid pore former or applying this composition to a substrate and curing the composition to form the porous matrix and additional pores formed by means of the pore former. The binder sol is a sol which forms a porous, solid, inorganic binder phase. Additional pores are built into the porous matrix by means of the pore former, so that a heteroporous matrix is formed.

By means of the process of the invention, the additional pores in the matrix can be matched to the desired properties, e.g. in respect of the pore size, in a simple manner by appropriate choice of the pore former and the amount used. The additional pores are preferably macropores, i.e. pores having a mean pore diameter of more than 50 nm. However, the mean pore diameter is usually at least 300 nm and in particular at least 0.5 μm. The insulation material of the invention preferably has additional pores in the matrix which have a mean pore diameter in the micron range, i.e. about 1 μm or above, e.g. from 1 μm to 1000 μm, preferably from about 1 μm to 500 μm.

The pore diameter is preferably determined by Hg porosimetry. Other possibilities are, for example, the BET method and electron microscopy. Depending on the size range of the pores (e.g. in the case of the small pores of the matrix), other measurement methods can be more advantageous. If Hg porosimetry is not suitable, the methods described in, for example, Ullmann's Encyklopädie der technischen Chemie, 4th edition, vol. 5, pages 751 and 752, can be employed. An indirect estimation or determination can be obtained for the additional pores from the internal diameter of the hollow bodies or the mean particle diameter of the thermally decomposable or vaporizable particles used, as long as no changes occur during production of the insulation material.

The mean pore diameter of the porous matrix is usually smaller than the mean pore diameter of the additional pores, preferably significantly smaller, e.g. the mean pore diameter of the additional pores derived from the pore former is, for example, at least 3 times, preferably at least 5 times, larger than the mean pore diameter of the porous matrix. The pores of the matrix are generally fine pores in the submicron range (smaller than 1 μm). In accordance with the nomenclature of IUPAC, the matrix is a microporous, mesoporous or macroporous matrix in which the mean pore diameter is preferably below 200 nm, particularly preferably below 50 nm (mesoporous) and very particularly preferably below 2 nm (microporous).

The pore size of the matrix can also, if necessary, be determined on a sample produced under the same conditions but without use of a pore former. These results can in turn be taken into account, if necessary, in the determination of the size of the additional pores.

The volume ratio of total volume of the pores (matrix pores+additional pores) to matrix in the finished insulation material is preferably such that at least 10% by volume of pores and correspondingly not more than 90% by volume of matrix, preferably at least 12% by volume of pores and not more than 88% by volume of matrix and particularly preferably at least 15% by volume of pores and not more than 85% by volume of matrix, are present. An advantageous maximum limit for the volume ratio is not more than 95% by volume of pores and at least 5% by volume of matrix. In the case of hollow bodies, the material enclosing the hollow space or spaces is calculated as the matrix volume. In general, the proportion by volume of the additional pores is significantly greater than the proportion by volume of the matrix pores.

The composition used according to the invention comprises a sol of nanoparticles and/or polycondensates or precursors thereof. Nanoparticles are nanosize, inorganic solid particles. Preference is given to nanoparticles comprising metal, including metal alloys, metal compounds, in particular metal chalcogenides, particularly preferably oxides and sulfides, with metals including B, Si and Ge for the present purposes. It is possible to use one type of nanoparticles or a mixture of nanoparticles.

The nanoparticles can be composed of any metal compounds. Examples are (optionally hydrated) oxides such as ZnO, CdO, SiO₂, GeO₂, TiO₂, ZrO₂, CeO₂, SnO₂, Al₂O₃ (in particular boehmite, AlO(OH), also as aluminum hydroxide), B₂O₃, In₂O₃, La₂O₃, Fe₂O₃, Fe₃O₄, Cu₂O, Ta₂O₅, Nb₂O₅, V₂O₅, MoO₃ or WO₃; further chalcogenides such as sulfides (e.g. CdS, ZnS, PbS and Ag₂S), selenides (e.g. GaSe, CdSe and ZnSe) and tellurides (e.g. ZnTe or CdTe); halides, such as AgCl, AgBr, AgI, CuCl, CuBr, CdI₂ and PbI₂; carbides such as CdC₂ or SiC; arsenides such as AlAs, GaAs and GeAs; antimonides such as InSb; nitrides such as BN, AlN, Si₃N₄ and Ti₃N₄; phosphides such as GaP, InP, Zn₃P₂ and Cd₃P₂; phosphides such as GaP, InP, Zn₃P₂ and Cd₃P₂; phosphates, silicates, zirconates, aluminates, stannates and the corresponding mixed oxides (e.g. indium-tin oxide (ITO), antimony-tin oxide (ATO), fluorine-doped tin oxide (FTO), luminous pigments comprising Y- or Eu-containing compounds, spinels, ferrites or mixed oxides having a Perovskite structure such as BaTiO₃ and PbTiO₃).

The nanoparticles are preferably an oxide or hydrated oxide of Si, Ge, Al, B, Zn, Cd, Ti, Zr, Ce, Sn, In, La, Fe, Cu, Ta, Nb, V, Mo or W, particularly preferably Si, Al, B, Ti and Zr. Particular preference is given to using oxides or hydrated oxides. Preferred nanosize inorganic solid particles are SiO₂, Al₂O₃, AlOOH, Ta₂O₅, ZrO₂ and TiO₂, with SiO₂ being most preferred.

These nanosize particles can be produced in a customary fashion, e.g. by flame pyrolysis, plasma processes, colloid techniques, sol-gel processes, controlled nucleation and growth processes, MOCVD processes and emulsion processes. These processes are comprehensively described in the literature. The sol-gel process is explained below.

The nanoparticles can be used in the form of a powder or directly as a dispersion in a dispersion medium. Examples of commercially available dispersions are the aqueous silica sols of Bayer AG (Levasile®) and colloidal organosols of Nissan Chemicals (IPA-ST, MA-ST, MEK-ST, MIBK-ST). Powders available are, for example, pyrogenic silicas from Degussa (Aerosil products).

The nanoparticles have a mean particle diameter (volume average, measurement: if possible by X-ray analysis, otherwise dynamic laser light scattering using an ultrafine particle analyzer: Ultrafine Particle Analyser (UPA), Leeds Northrup) below 1 μm, in general below 500 nm. The nanoparticles preferably have mean particle diameter of not more than 200 nm, preferably not more than 100 nm and in particular not more than 50 nm, and more than 1 nm and preferably more than 2 nm, e.g. from 1 to 20 nm.

The nanoparticles are, in particular, present in the form of a sol or a suspension which is stabilized by conventional methods. Stabilization can, for example, be effected by setting the surface charge of the particles and thus the zeta potential of the particles. The zeta potential can be set to the desired level by, for example, changing the pH or modifying the surface of the particles with charged groups. This can be achieved using, for example, inorganic or organic acids. Stabilization of the nanoparticles can also be effected by modifying the surface by means of other compounds or groups. The modification of the surface is explained below.

In an advantageous embodiment, a nanocomposite comprising surface-modified nanoparticles is used as binder. The nanocomposite comprising surface-modified nanoparticles can be obtained from the reaction of hydrolyzable compounds or organic compounds having suitable functional groups with the nanoparticles. The hydrolyzable compounds may additionally be able to form a polycondensate into which the surface-modified nanoparticles can be embedded.

The modification of the surface of nanosize solid particles is a known process as has been described by the applicant, e.g. in WO 93/21127 (DE 4212633) or WO 96/31572. The production of the surface-modified nanoparticles can in principle be carried out in two different ways, namely firstly by modification of the surface of previously produced nanoparticles and secondly by production of these nanoparticles using one or more compounds which have appropriate functional groups. These two routes are explained in more detail in the above-mentioned patent applications.

Suitable surface modifiers, in particular for modifying the surface of existing nanoparticles, are, for example, organic acids or inorganic compounds having other functional groups or hydrolyzable silanes having at least one nonhydrolyzable group which can react and/or (at least) interact with groups present on the surface of the solid particles so that a sufficient bond strength is obtained. For example, reactive groups as residual valences such as hydroxy groups and oxy groups are present as surface groups on nanoparticles, e.g. metal oxides. Another form of surface modification utilizes complexation, polar interactions or ionic bonds as bonding process.

Modification of the surface of the nanosize particles can, for example, be effected by mixing the nanosize particles with suitable surface modifiers as described below, if appropriate in a solvent and in the presence of a catalyst. In the case of silanes as surface modifiers, stirring for a number of hours with the nanosize particles at room temperature, for example, is frequently sufficient for modification. Naturally, appropriate conditions such as temperature, ratios of amounts, duration of the reaction, etc. , depend on the specific reactants and the desired degree of occupation of the surface.

The surface modifiers can form, for example, covalent, ionic (salt-like) or coordinate bonds to the surface of the nanosize solid particles, while examples of pure interactions which may be mentioned are dipole-dipole interactions, hydrogen bonds and van der Waals interactions. Preference is given to the formation of covalent, ionic or coordinate bonds. For the purposes of the present invention, a coordinate bond is formation of a complex. An acid/base reaction of the Brönsted or Lewis type, complex formation or an esterification, for example, can take place between the surface modifier and the particle.

According to the invention, the surface modifiers preferably also have a relatively low molecular weight. For example, the molecular weight can be less than 1500, in particular less that 1000 and preferably less than 500 or less than 400 or even less than 300. This of course does not rule out a significantly higher molecular weight of the compounds (e.g. up to 2000 and more).

Examples of suitable functional groups of the surface modifiers for bonding to the nanoparticles are carboxyl groups, anhydride groups, acid amide groups, (primary, secondary, tertiary and quaternary) amino groups, SiOH groups, hydrolyzable radicals of silanes (group SiX described below in the formula (I)) and C—H-acid groups, e.g. β-dicarbonyl compounds. It is also possible for a plurality of these groups to be simultaneously present in one molecule (betaines, amino acids, EDTA, etc.).

Examples of compounds used for surface modification are unsubstituted or substituted (e.g. by hydroxy), saturated or unsaturated monocarboxylic and polycarboxylic acids (preferably monocarboxylic acids) having from 1 to 24 carbon atoms (e.g. formic acid, acetic acid, propionic acid, butyric acid, pentanoic acid, hexanoic acid, acrylic acid, methacrylic acid, crotonic acid, citric acid, adipic acid, succinic acid, glutaric acid, oxalic acid, maleic acid and fumaric acid) and monocarboxylic acids which have from 1 to 24 carbon atoms and ether bonds (e.g. methoxyacetic acid, dioxaheptanoic acid and 3,6,9-trioxadecanoic acid) and also their anhydrides, esters (preferably C₁-C₄-alkyl esters) and amides, e.g. methyl methacrylate.

Also suitable are amine compounds such as ammonium salts and monoamines or polyamines. Examples of these surface modifiers are quaternary ammonium salts of the formula NR¹R²R⁴⁺X⁻ where R¹ to R⁴ are identical or different aliphatic, aromatic or cycloaliphatic groups preferably having from 1 to 12, in particular from 1 to 8, carbon atoms, e.g. alkyl groups having from 1 to 12, in particular from 1 to 8 and particularly preferably from 1 to 6, carbon atoms (e.g. methyl, ethyl, n- and i-propyl, butyl or hexyl), and X⁻ is an inorganic or organic anion, e.g. acetate, OH⁻, Cl⁻ Br⁻ or I⁻; monoamines and polyamines, in particular those of the general formula R₃₋ₙNHₙ, where n=0, 1 or 2 and the radicals R are, independently of one another, alkyl groups having from 1 to 12, in particular from 1 to 8 and particularly preferably from 1 to 6, carbon atoms, and ethylenepolyamines (e.g. ethylenediamine, diethylenetriamine, etc. ). Further examples are amino acids; imines; β-dicarbonyl compounds having from 4 to 12, in particular from 5 to 8, carbon atoms, e.g. acetylacetone, 2,4-hexanedione, 3,5-heptanedione, acetoacetic acid and C₁-C₄-alkyl acetoacetates, e.g. ethyl acetoacetate; and hydrolyzable silanes such the hydrolyzable silanes having at least one hydrolyzable group, e.g. the silanes of the general formulae (I) and (II).

The modification of the surface of the nanoparticles can also be carried out using hydrolyzable silanes and/or organosilanes or oligomers thereof, with particular preference being given to at least one silane having a nonhydrolyzable group. This surface modification using hydrolyzable silanes is particularly preferred in the case of SiO₂ nanoparticles. The nanocomposite comprising nanoparticles is therefore preferably obtainable by reacting nanoparticles with one or more silanes of the general formula:
RₙSiX₍₄₋ₙ₎ (I)
where the radicals X are identical or different and are hydrolyzable groups or hydroxy groups, the radicals R are identical or different and are nonhydrolyzable groups and n is 0, 1, 2 or 3, or an oligomer derived therefrom, with preference being given to n being greater than 0 for a silane.

In the general formula (I), the hydrolyzable groups X, which can be identical or different from one another, are, for example, hydrogen or halogen (F, Cl, Br or I), alkoxy (preferably C₁₋₆-alkoxy such as methoxy, ethoxy, n-propoxy, i-propoxy and butoxy), aryloxy (preferably C₆₋₁₀-aryloxy such as phenoxy), acyloxy (preferably C₁₋₆-acyloxy such as acetoxy or propionyloxy), alkylcarbonyl (preferably C₂₋₇-alkylcarbonyl such as acetyl), amino, monoalkylamino or dialkylamino preferably having from 1 to 12, in particular from 1 to 6, carbon atoms. Preferred hydrolyzable radicals are halogen, alkoxy groups and acyloxy groups. Particularly preferred hydrolyzable radicals are C₁₋₄-alkoxy groups, in particular methoxy and ethoxy.

The nonhydrolyzable radicals R, which can be identical or different from one another, can be nonhydrolyzable radicals R having a functional group via which, for example, crosslinking can occur or nonhydrolyzable radicals R without a functional group. The nonhydrolyzable radical R without a functional group is, for example, alkyl (preferably C₁₋₈-alkyl such as methyl, ethyl, n-propyl, isopropyl, n-butyl, s-butyl and tert-butyl, pentyl, hexyl, octyl or cyclohexyl), alkenyl, alkynyl, aryl (preferably C₆₋₁₀-aryl such as phenyl and naphthyl) and also corresponding alkylaryls and arylalkyls. The radicals R and X may, if appropriate, have one or more customary substituents such as halogen or alkoxy.

Specific examples of functional groups are epoxide, hydroxy, ether, amino, monoalkylamino, dialkylamino, substituted or unsubstituted anilino, amide, carboxy, acryl, acryloxy, methacryl, methacryloxy, mercapto, cyano, alkoxy, isocyanato, aldehyde, alkylcarbonyl, acid anhydride and phosphoric acid groups. These functional groups are bound to the silicon atom via alkylene, alkenylene or arylene bridging groups which may be interrupted by oxygen atoms or —NH— groups. The bridging groups and any substituents present, as in the case of the alkylamino groups, are derived, for example, from the alkyl, alkenyl or aryl radicals mentioned above and below. The radical R can naturally also have more than one functional group.

Specific examples of nonhydrolyzable radicals R having functional groups via which crosslinking is possible are a glycidyl- or glycidyloxy-(C₁₋₂₀)-alkylene radical such as β-glycidyloxyethyl, γ-glycidyloxypropyl, δ-glycidyloxybutyl, ε-glycidyloxypentyl, ω-glycidyloxyhexyl and 2-(3,4-epoxycyclohexyl)ethyl, a (meth)acryloxy-(C₁₋₆)-alkylene radical, where (C₁₋₆)-alkylene can be, for example, methylene, ethylene, propylene or butylene, and a 3-isocyanatopropyl radical.

The surface of the nanoparticles is particularly preferably modified by means of one or more silanes of the formula:
RₙSiX₍₄₋ₙ₎ (I)
where the radicals X are identical or different and are hydrolyzable groups or hydroxy groups, the radicals R are identical or different and are nonhydrolyzable groups selected from among alkyl, alkenyl, alkynyl, aryl, aralkyl and alkylaryl and n is 0, 1, 2 or 3, with n preferably being 1, 2 or 3 for at least one silane, or an oligomer derived therefrom.

The nonhydrolyzable radical R is alkyl (preferably C₁₋₈-alkyl, such as methyl, ethyl, n-propyl, isopropyl, n-butyl, sec-butyl and tert-butyl, pentyl, hexyl, octyl or cyclohexyl), alkenyl (preferably C₂₋₆-alkenyl such as vinyl, 1-propenyl, 2-propenyl and butenyl), alkynyl (preferably C₂₋₆-alkynyl such as acetylenyl and propargyl), aryl (preferably C₆₋₁₀-aryl such as phenyl and naphthyl) or an alkylaryl or aralkyl, preferably derived from the abovementioned alkyl and aryl groups, e.g. benzyl, phenylethyl, tolyl and ethylphenyl). The radicals R and X may, if appropriate, have one or more customary substituents, e.g. halogen or alkyloxy. Preferred radicals R are alkyl, alkenyl and alkynyl having from 1 to 4 carbon atoms and aryl, aralkyl and alkylaryl having from 6 to 10 carbon atoms.

Preferred examples are alkyltrialkoxysilanes such as methyltri(m)ethoxysilane, dialkyldialkoxysilanes, aryltrialkoxysilanes such as phenyltri(m)ethoxysilane and diaryldialkoxysilanes such as diphenyldi(m)ethoxysilane, with alkyl particularly preferably being C₁₋₄-alkyl and alkoxy particularly preferably being methoxy or ethoxy. Preferred compounds are methyltriethoxysilane (MTEOS), ethyltriethoxysilane, phenyltriethoxysilane (PTEOS), dimethyldimethoxysilane and dimethyldiethoxysilane.

In a particularly preferred embodiment, the surface modification is carried out using at least one silane of the formula RₙSiX₄₋ₙ (I) where n=1 or 2, and at least one silane of the formula SiX₄ (II), where X is as defined in formula (I).

Examples of silanes of the formula (II) are Si(OCH₃)₄, Si(OC₂H₅)₄, Si(O-n- or -i-C₃H₇)₄, Si(OC₄H₉)₄, SiCl₄, Si(OOCCH₃)₄. Among these silanes, preference is given to tetraalkoxysilanes, with those having C₁-C₄-alkoxy groups being particularly preferred. Tetramethoxysilane and tetraethoxysilane (TEOS) are very particularly preferred, with TEOS being most preferred.

The surface modification is preferably carried out using a tetraalkoxysilane and at least one silane selected from among alkyltrialkoxysilanes, dialkyldialkoxysilanes, aryltrialkoxysilanes and diaryldialkoxysilanes, with mixtures of methyltriethoxysilane (MTEOS) and TEOS being particularly preferred. When part of the MTEOS is replaced by dimethyldiethoxysilane, more flexible products are obtained after curing, which can be advantageous. It is also possible to use, for example, only MTEOS.

In the preferred embodiments, SiO₂ nanoparticles are used, so that the most preferred system comprises a mixture of MTEOS and TEOS as starting materials for surface modification and, if appropriate, condensate formation and SiO₂ as nanosize solid particles. In the case of SiO₂ nanoparticles which are different from SiO₂, the use of pure organic compounds for surface modification can frequently be preferable.

The composition can comprise, instead of or in addition to the nanoparticles, polycondensates or precursors thereof as binder sol. Polycondensates can be obtained by hydrolysis and condensation reactions of hydrolyzable compounds. As condensation progresses, the degree of condensation increases and the porous matrix is finally the end product. For the purposes of the present invention, precursors of the polycondensates are the hydrolyzable compounds, the hydrolysis products and the condensation products having a relatively low degree of condensation. The sols in which these polycondensates or precursors are present are preferably obtained by the sol-gel process, which is described below.

In a preferred embodiment, polycondensates or precursors thereof are present and the surface-modified or unmodified nanoparticles are embedded therein. In a preferred embodiment, the composition comprises a nanocomposite which is obtainable by hydrolysis and condensation of hydrolyzable compounds in the presence of the nanoparticles, preferably by the sol-gel process, with, depending on the amount of hydrolyzable compounds used, polycondensates or a precursor thereof being able to be formed in addition to the surface modification.

In the sol-gel process, hydrolyzable compounds are usually hydrolyzed and, if appropriate, at least partially condensed by means of water, if appropriate in the presence of acidic or basic catalysts. The hydrolysis and/or condensation reactions lead to formation of polycondensates or precursors thereof having, for example, hydroxy groups, oxo groups and/or oxo bridges. It is possible to use stoichiometric amounts of water, but smaller or larger amounts can also be used. The sol which forms can be brought to the viscosity desired for the composition by means of suitable parameters, e.g. degree of condensation, solvent or pH. Further details of the sol-gel process are described, for example, in C. J. Brinker, G. W. Scherer: “Sol-Gel Science—The Physics and Chemistry of Sol-Gel-Processing”, Academic Press, Boston, San Diego, New York, Sydney (1990). The reaction can be carried out in the presence of an organic solvent, preferably an alcohol. The alcohol can also be formed during the reaction if alkoxides are used as starting materials.

In the sol-gel process, sols containing nanoparticles or sols containing polycondensates can be obtained. Thus, for example, acid-catalyzed hydrolysis of hydrolyzable silicon compounds can lead to sols which contain polycondensates but no nanoparticles (“polymerized sol”) where base catalysis can lead to sols containing nanoparticles (“colloid sol”).

To prepare the polycondensates or the precursors thereof, hydrolyzable compounds of glass- or ceramic-forming elements or metals M are used, in particular elements from main groups III to V and/or transition groups II to V of the Periodic Table of the Elements and Mg. Preference is given to the elements Si, Al, B, Sn, Ti, Zr, Mg, V or Zn, in particular compounds of Si, Al, Ti, Zr and Mg or mixtures of two or more of these elements. Of course, other glass- or ceramic-forming elements M can be incorporated, in particular elements of main groups I and II of the Periodic Table (e.g. Na, K and Ca) and transition groups VI to VIII of the Periodic Table (e.g. Mn, Cr, Fe and Ni). It is also possible to use lanthanides.

The hydrolyzable compounds which can be used have, in particular, the general formula MX_{b}, where M is the above-defined glass- or ceramic-forming element M, X is a hydrolyzable group or hydroxy, with two groups X being able to be replaced by an oxo group, and b corresponds to the valence of the element and is usually 3 or 4. Examples of hydrolyzable groups X, which can be identical or different from one another, are hydrogen, halogen (F, Cl, Br or I, in particular Cl or Br), alkoxy (e.g. C₁₋₆-alkoxy such as methoxy, ethoxy, n-propoxy, i-propoxy and n-, i-, sec- or tert-butoxy), aryloxy (preferably c₆₋₁₀-aryloxy such as phenoxy), alkaryloxy, e.g. benzoyloxy, acyloxy (e.g. C₁₋₆-acyloxy, preferably C₁₋₄-acryloxy such as acetoxy or propionoyloxy), amino and alkylcarbonyl (e.g. C₂₋₇-alkylcarbonyl such as acetyl). It is also possible for two or three groups X to be joined to one another, e.g. in Si-polyol complexes with glycol, glycerol or catechol. The groups mentioned may, if appropriate, contain substituents such as halogen or alkoxy. Preferred hydrolyzable radicals X are halogen, alkoxy groups and acyloxy groups.

Preferred hydrolyzable compounds are compounds of silicon. Specific examples are the abovementioned silanes of the formula (II). The hydrolyzable compounds can also bear nonhydrolyzable substituents. In this case, organically modified inorganic polycondensates or precursors thereof can be formed. Examples of such hydrolyzable compounds having nonhydrolyzable substituents are the silanes of the formula (I) in which n is greater than 0. Mixtures of hydrolyzable compounds with and without nonhydrolyzable substituents can also be used for the polycondensates. Particularly when refractory materials are to be produced, it can be preferred to use at least some hydrolyzable compounds of, for example, Al, Zr and/or Ti as refractory components.

Examples of titanium compounds of the formula TiX₄ are TiCl₄, Ti(OCH₃)₄, Ti(OC₂H₅)₄, Ti(2-ethylhexoxy)₄, Ti(n-OC₃H₇)₄ or Ti(i-OC₃H₇)₄. Further examples of hydrolyzable compounds of elements M which can be used are Al(OCH₃)₃, Al(OC₂H₅)₃, Al(O-n-C₃H₇)₃, Al(O-i-C₃H₇)₃, Al(O-n-C₄H₉)₃, Al(O-sec-C₄H₉)₃, AlCl₃, AlCl(OH)₂, Al(OC₂H₄OC₄H₉)₃, ZrCl₄, Zr(OC₂H₅)₄, Zr(O-n-C₃H₇)₄, Zr(O-i-C₃H₇)₄, Zr(OC₄H₉)₄, ZrOCl₂, Zr(2-ethylethoxy)₄ and also Zr compounds having complexing radicals, e.g. β-diketone and (meth)acryl radicals, sodium methoxide, potassium acetate, boric acid, BCl₃, B(OCH₃)₃, b(OC₂H₅)₃, SnCl₄, Sn(OCH₃)₄, Sn(OC₂H₅)₄, VOCl₃ and VO(OCH₃)₃.

In preferred embodiments in which hydrolyzable silanes of the formula (I) having nonhydrolyzable groups and hydrolyzable starting compounds without nonhydrolyzable groups are used, it is preferred that at least 10 mol % of all hydrolyzable compounds used also possess non-hydrolyzable groups. Preference is given to at least 50 mol %, more preferably at least 60 mol %, of the hydrolyzable compounds used containing at least one nonhydrolyzable group. The ratio of hydrolyzable compounds without nonhydrolyzable groups to hydrolyzable compounds having at least one nonhydrolyzable group is, for example, preferably 5-50 mol % to 50-95 mol % (5-50:50-95) and preferably from 1:1 to 1:6 and more preferably from 1:3 to 1:5, e.g. 1:4. It is also possible to use previously partially reacted oligomers as starting material, but the amounts stated are always based on monomeric starting compounds.

When hydrolyzable compounds are used for preparing polycondensates and nanoparticles, the ratio of the hydrolyzable compounds to the nanoparticles is preferably set so that the atomic ratio of the glass or ceramic-forming elements (element M as central element of the hydrolyzable compounds, as defined above) of the hydrolyzable compounds to the metal atoms (including Si, B, Ge, as defined above) in the nanoparticles is in the range from 5:1 to 1:2, in particular from 3:1 to 1:1.

A matrix consisting predominantly of SiO₂ is stable up to below 1200° C. (softening point of SiO₂). In a preferred embodiment, the composition can further comprise refractory components. In this way, particularly high-temperature-resistant insulation materials can be formed. The addition of a refractory component makes it possible to obtain matrices which have a softening point above 1200° C., preferably above 1300° C. and particularly preferably above 1400° C.

For the present purposes, refractory components are components which can improve the thermal stability, e.g. compared to a matrix based purely on SiO₂. The addition of the refractory component preferably results in a softening point above 1200° C. for the material.

When an Al component is added as refractory component, this can react, for example, with Si components to form mullite, an oxide of aluminum and silicon whose heat resistance extends to far above 1600° C. In the case of a Zr component, a zirconium silicate, which is likewise a refractory composition, can be formed. Rutile can also be used as refractory material. Examples of elements which can be incorporated via the refractory component are Al, Zr, Ti, Mg and Ca. Depending on the specific case, even a relatively small amount of a refractory component in an SiO₂ matrix may result in an increase in the heat resistance. A person skilled in the art will be familiar with suitable refractory components and the necessary ratios of amounts.

The additional refractory component which does not contain any Si can be incorporated into the matrix by addition of corresponding nanoparticles and/or hydrolyzable compounds or polycondensates or precursors obtained therefrom to the composition. It is possible to use the nanoparticles and the hydrolyzable compounds or polycondensates or precursors thereof which have been mentioned above by way of example for the production of the binder or the nanocomposite, as long as an improvement in the heat resistance is achieved.

Preferred examples of refractory components in the form of nanoparticles are titanium oxide, zirconium oxide and aluminum oxide, which may, if appropriate, be hydrated. They are preferably used in the form of a sol. These nanoparticles can be used in addition to or in place of SiO₂ particles, but it is usually preferred that at least part of the total nanoparticles used are composed of SiO₂. Examples of hydrolyzable compounds which can be used as refractory component are the abovementioned hydrolyzable compounds of Al, Zr and Ti or polycondensates thereof or copolycondensates thereof with other hydrolyzable compounds, e.g. Si compounds, or precursors thereof.

The composition according to the invention, in particular when the additional refractory component is present, surprisingly makes it possible for the pores to be formed using hollow bodies which themselves do not have sufficient thermal stability for the envisaged temperature range in which the insulation material is to be used. This astonishing effect is illustrated below for the example of hollow glass spheres.

Customary glass compositions are generally resistant to temperatures up to 500 or 600° C., in exceptional cases up to 700° C. When hollow glass spheres are used for forming the pores (see details below), the use of a composition comprising the hollow glass spheres can result in formation of a shaped body which retains its shape even after softening of the glass at high temperatures if it is ensured that the binder, preferably the nanocomposite binder, forms a continuous phase in which the glass spheres are embedded. Even melting of the spheres will not adversely affect the shape, so that a higher heat distortion resistance is obtained in a molding according to the invention by means of this system than is possible, for example, in the case of sintered glass spheres or glass foams.

In the case of a nonuniform distribution or a percolating glass sphere system, the heat resistance of the molding is restricted to the heat resistance of the glass. However, the insulation material of the invention having a matrix composed of the binder which is solid in the cured state makes it possible to obtain a structure in the molding which is stable significantly above the glass transition temperature of the hollow spheres. Thus, an insulating molding having a significantly higher heat resistance than the heat resistance of the component which brings about the insulating action (e.g. glass) is obtained. Furthermore, the process of the invention enables the pores to be formed even without use of hollow glass spheres, so that any disadvantages caused by the glass can be avoided and a variable route for production of the materials is available.

Solvents which can be used for the composition include both water and organic solvents or mixtures. These are the customary solvents used in the field of coating or moldings. Examples of suitable organic solvents are alcohols, preferably lower aliphatic alcohols (C₁-C₈-alcohols) such as methanol, ethanol, 1-propanol, i-propanol and 1-butanol, ketones, preferably lower dialkyl ketones such as acetone and methyl isobutyl ketone, ethers, preferably lower dialkyl ethers, e.g. diethyl ether, or diol monoethers, amides such as dimethylformamide, tetrahydrofuran, dioxane, sulfoxides, sulfones or butyl glycol and mixtures thereof. Preference is given to using alcohols. It is also possible to use high-boiling solvents. In the sol-gel process, the solvent can, if appropriate, be an alcohol formed from the alkoxide compound in the hydrolysis.

In a preferred embodiment, the matrix-forming composition, i.e. the composition which comprises the nanoparticles and/or polycondensates or precursors thereof or nanocomposites (binder) but not yet any components which are used for pore formation, has a solids content of from 30 to 60% by weight. The processing consistency can be adjusted by varying the solids content, taking into account the type and amount of the material forming the additional pores which is to be used.

To form the additional pores, the composition further comprises one or more solid pore formers which form additional pores which together with the matrix pores can form a heteroporous structure comprising pores of differing mean sizes. The formation of the additional pores in the insulation material can be brought about by addition of hollow bodies to the composition comprising the binder. These hollow, solid particles can have any shape, but are generally approximately spherical hollow bodies. The shell of the hollow bodies can be selected from among any materials. Examples are glass, ceramic or plastic, e.g. hollow glass spheres, hollow fused alumina spheres or hollow plastic spheres, with hollow glass spheres and in particular hollow glass microspheres being preferred. Such hollow bodies are commercially available.

The pores are in this case formed by the hollow space of the bodies, so that the mean internal diameter of the hollow bodies generally corresponds to the mean pore diameter of the pores formed, as long as no change in a particular size fraction occurs, e.g. as a result of partial destruction of some hollow bodies. Naturally, the number of pores obtained depends on the ratio of the percentage of hollow bodies used to the amount of binder. On the basis of the above, the type and size of the hollow bodies and the amount added can readily be determined by a person skilled in the art as a function of the desired proportion of pores in the matrix and the desired mean pore diameter. It is naturally also possible to use hollow bodies of various sizes in order to obtain pores of differing sizes.

Although hollow metal spheres can in principle also be used, they result in a higher thermal conductivity, a greater weight and can, owing to differing thermal expansions, produce stresses in the insulation material. In the event of complete dissolution of the metal matrix of such hollow spheres and incorporation of the metal into the binder matrix, e.g. by oxidation of aluminum when hollow Al spheres are used, the use of hollow metal spheres could be useful, with the aluminum oxide formed even providing a refractory component.

When hollow glass spheres are used, an advantageous ratio of matrix to hollow glass spheres is, for example, such that the matrix makes up from 1 to 20% by weight of the finished layer or the finished molding.

As an alternative, the additional pores can be obtained by addition of thermally decomposable or vaporizable particles to the composition and subsequent heat treatment to decompose and/or vaporize the particles. For the present purposes, thermally decomposable particles are particles which decompose at the temperature used in the heat treatment and are at least mostly and preferably completely converted into volatile, sublimable or vaporizable components.

Here, the use of thermally decomposable or vaporizable particles which are also hollow can be particularly preferred, since compared to a solid particle less material has to be decomposed to obtain pores having approximately the same diameter. Suitable particles for this purpose are, for example, hollow bodies composed of a thermally decomposable polymer, e.g. hollow polystyrene spheres.

The mean pore diameter obtained can correspond approximately to the mean particle diameter of the thermally decomposable particles used. The pores formed can also be larger than the particle size of the thermally decomposable particles as a result of liberated gases. As in the case of the hollow bodies, a person skilled in the art can readily determine the type and size of the decomposable particles and the amount added as a function of the desired proportion of pores in the matrix and the desired mean pore diameter. Naturally, it is also possible to use decomposable particles of various sizes in order to obtain pores of differing sizes.

The thermal decomposability of the particles can, for example, result from the thermal lability of the compounds and/or from the oxidizability. In any case, the particles are decomposed under the action of heat into volatile or vaporizable components which can escape from the matrix being formed so as to produce the pores. The particles are preferably materials which decompose without leaving a residue. However, residues may also remain as long as the desired pores are formed.

Examples of suitable thermally decomposable or vaporizable materials are metal nitrates, NH₄Cl, carbonates, organic salts such as carboxylic acid salts, carbon black or polymers, e.g. in the form of polymer spheres, which are oxidatively destroyed at the temperatures used and are used, for example, as powder of a suitable size. Further specific examples of thermally decomposable or vaporizable materials are vinyl acetate-ethylene copolymer powder, polyvinyl alcohol powder, phenolic plastic powder, urea-formaldehyde resin powder, polyester resin powder, flour, proteins, polysaccharides, waxes, silicone resin powder and wood flour.

It is also possible to use customary intumescents or blowing agents known to those skilled in the art, for example expandable graphite or substances such as melamines which liberate nitrogen. The intumescents or blowing agents can lead to a volume expansion of the binder. It is also possible to use expanding agents which decompose as a result of chemical reaction or catalysis, so that in this case no heat treatment is necessary to form the additional pores.

It is preferred that the particles used are not soluble in the composition to which they are added or the dissolution rate is sufficiently low. An appropriate dispersibility should also be present. A person skilled in the art can choose the particles accordingly. The mean particle size is, as indicated above, selected as a function of the desired pore size, with finely divided materials being advantageous for leaving fine pores. To achieve a good insulating action, particles having a mean particle diameter (volume average, laser light scattering method (valuation by the Mie method)) of from 1 to 1000 μm, preferably from 1 to 500 μm, are generally suitable, but smaller particles can also be used.

Since the matrix compositions used according to the invention remain porous up to relatively high temperatures, oxygen (e.g. from the air or as a result of deliberate introduction) can be introduced into the matrix in order to bring about oxidative decomposition processes in the systems even at the relatively high temperatures which may be necessary for the decomposition and volatile decomposition or combustion products can escape from the system.

Apart from the components mentioned, further additives known to those skilled in the art can be added if required. For example, a fiber material, e.g. glass fibers, can be added in order to increase the strength. The components of the composition can be added in any order.

Organic monomers, oligomers or polymers, for example, can be added as additive to the composition in order to adjust the rheology or achieve control of the bond strength of the molding. These additives can also have a binder function. Suitable compounds are known to those skilled in the art. Examples of materials which can be used are organic monomers, oligomers or polymers which have polar groups such as hydroxyl, primary, secondary or tertiary amino, carboxyl or carboxylate groups. Typical examples are polyvinyl alcohol, polyvinylpyrrolidone, polyacrylamide, polyvinylpyridine, polyallylamine, polyacrylic acid, polyvinyl acetate, polymethyl methacrylate, starch, gum arabic, other polymers or oligomeric alcohols such as polyethylene polyvinyl alcohol copolymers, polyethylene glycol, polypropylene glycol and poly(4-vinylphenol) or monomers or oligomers derived therefrom. As polyvinyl alcohol, it is possible to use, for example, the commercially available Mowiol® 18-88.

The insulation material can be used as a coating or a molding, so that the above-described composition can serve as coating composition or as molding composition. Naturally, the composition can be adapted for the desired application in a manner known to those skilled in the art, e.g. in respect of the viscosity.

In the case of coating, the composition is applied as coating composition to a substrate by the customary coating methods, e.g. dipping, rolling, doctor blade coating, flooding, drawing, spraying, spin coating or painting. The substrate can have any appropriate shape. The substrate can be any material suitable for the purpose. Examples of suitable materials are metals or metal alloys, glass, ceramic, including oxide ceramic, glass-ceramic, building materials such as stone, or plastic. The substrate can have been provided with a surface layer, e.g. metallization, enameling, a ceramic layer or a surface coating.

The insulation material is preferably used as a molding, with all molding techniques known to those skilled in the art being able to be used, e.g. a mold. Complex geometries can also be obtained in a simple manner.

After coating or shaping, the composition is cured. This can be carried out at room temperature (about 20° C.), but a heat treatment is usually carried out. The heat treatment can serve not only to cure the composition but also to achieve partial densification, heating and/or burning-out of organic constituents. When thermally decomposable or vaporizable particles are used, the heat treatment also serves to form the additional pores. The binder used according to the invention forms a porous matrix after curing.

The coating or molding is preferably subjected to a heat treatment to bring about curing, and any thermally decomposable vaporizable particles decomposed and vaporized during this treatment to form pores. The heat treatment for curing is preferably carried out at at least 40° C., preferably at least 100° C. particularly preferably at least 150° C. Particularly when the matrix being formed still contains organic components and/or thermally decomposable or vaporizable particles are used to form the additional pores, heat treatment at at least 300° C., preferably at least 350° C. or at least 400° C., is preferred, so that the organic constituents are burnt out and/or the additional pores are formed. The thermal stability of the material is also improved in this way. The minimum temperatures indicated are based on the maximum temperature used in a treatment step. The appropriate maximum temperature naturally depends on the starting material used and can readily be found by a person skilled in the art.

The heat treatment can be carried out in one step, but preference is given to carrying out at least two or three heat treatment steps, with higher temperatures generally being used in each subsequent step. Thus, for example, an optional partial drying step is carried out at relatively low temperatures of, for example, from room temperature to 60° C. This step is not absolutely necessary but particularly in the case of moldings, is advantageous and sometimes advisable in order to obtain the necessary initial strength.

The curing step, which can follow or is carried out directly without prior partial drying, can be carried out at room temperature or is achieved by heat treatment at at least 40° C., preferably at least 100° C. and in particular at least 150° C., preferably at least 300° C. and particularly preferably at least 350° C. Curing is preferably carried out in two stages by means of intermediate curing and final curing.

For intermediate curing, for example, a heat treatment can be carried out in, for example, a temperature range of ≧40° C., e.g. from 100 to 250° C. Final curing is then carried out at, for example, at least 300° C., preferably at least 350° C. or at least 400° C., with any organic components present being burnt out and/or thermally decomposable or vaporizable pore formers being driven off during this step to achieve final formation of the additional pores. The heat resistance and resistance to crack formation are also increased as a result.

The duration of the respective treatment steps depends on the material and the temperature used and can readily be determined by a person skilled in the art. Of course, the heat treatment steps can be controlled in a customary fashion by means of a temperature program, by means of the suitable heating and cooling rates and also the hold times.

If thermally decomposable or vaporizable particles are used to form the pores, the decomposition and formation of the pores occur during the heat treatment. The material and the temperature used are to be chosen so that the decomposition temperature is reached. The decomposition to form the pores generally takes place during the course of curing. When other blowing agents are used, pore formation occurs correspondingly in the manner known to those skilled in the art.

If the composition comprises organic components, e.g. in the form of organic radicals in the nanocomposite or in the form of organic oligomers or polymers used, these are burnt out by means of a heat treatment, so that an inorganic matrix remains. The appropriate temperature and time for burning out the organic components depends on the materials used and is known to those skilled in the art. The presence of organic components frequently reduces the risk of crack formation during curing.

When hydrolyzable silanes having functional groups via which crosslinking is possible (e.g. alkenyl, alkynyl or epoxide groups) are used, additional organic polymer crosslinking can occur at relatively high temperatures in the absence of O₂, as a result of which carbon reinforcement which can strengthen the pore structure can be built up during burn-out. Temporary organic crosslinking can be brought about catalytically if suitable functional groups are present.

A porous matrix can be obtained from the binder comprising nanoparticles and/or polycondensates or precursors thereof in the composition. The pore size can, for example, be regulated by means of the temperature and time employed in the heat treatment steps. The conditions for setting the porosity of the matrix are known to those skilled in the art. The matrix produced according to the invention surprisingly remains porous even at relatively high temperatures.

A high-temperature-resistant insulation material is obtained. The moldings obtained can be subjected to further shaping if required. Thus, the moldings are suitable for material-removing machining (e.g. mechanically or by means of radiation). They can also be provided with a coating.

Owing to its low thermal conductivity, the insulation material is very well suited to thermal insulation and can be used in an extremely wide temperature range, e.g. from −200° C. or from room temperature to temperatures as high as 2000° C.

Specific possible applications are insulation against heat and cold, e.g. for refrigerators, ovens, laboratory equipment and for industrial purposes as in metallurgy or in the glass industry, a combination of insulation and fire protection, thermal encapsulation of heat-sensitive components in the electronics sector and of cables. Further fields of use are the building sector, the transportation sector, e.g. for automobiles, trucks and aircraft, and in spaceflight.

The following examples illustrate the invention.

### EXAMPLE 1

An alcoholic binder dispersion having a solids content in the range from about 30 to 60% by weight is obtained by hydrolysis and condensation of TEOS and MTEOS in the presence of an aqueous silica sol. If necessary, the solvent is evaporated to adjust the viscosity. After addition of hollow glass microspheres, mixing is effected by means of a slow-running propeller stirrer so that a homogeneous molding mixture is obtained. The proportion of hollow spheres is selected so that a binder content of from 5 to 20% by weight is obtained in the cured shaped part. The processing consistency can be adjusted by varying the binder content.

The molding mixture is introduced and tamped in between the core and shell of a two-part aluminum mold. Immediately after filling the mold, the shell is taken off and the core together with the molding mixture pressed around the core is placed in a drying oven at 40° C. for 30 minutes to effect the partial drying of the molding mixture. In this way, the component can be given the initial strength necessary for further processing.

Before further curing, the component is removed from the core in order to avoid sticking to the core. The component is then placed in the drying oven again and the temperature is increased at about 5° C./min to 200° C. and held for about 12 hours. After slow cooling to RT, the finished molding is taken out. The molding is after-treated to make it crack-resistant for temperatures up to 500° C. For this purpose, the molding is heated at about 1 K/min to 500° C. in a convection oven, held at this temperature for 2 hours and cooled back down to RT at the same rate. The use of a convection oven in the last step is particularly preferred. The shaped part obtained has a thermal conductivity of 0.045 W/m·K.

### EXAMPLE 2

### High-temperature Insulation Materials Based on Nanocomposites which Form Refractory Mullite/zirconium Silicate

A. Binder Syntheses

a) MTZS 0.75

65.5 g of MTEOS and 19.1 g of TEOS are mixed. Half of the mixture is reacted with 49.7 g of zirconium oxide sol having a solids content of 60% by weight (29.82 g of IZCO in 19.88 g of water) and 0.4 ml of concentrated hydrochloric acid while stirring vigorously. After 5 minutes, the second half of the silane mixture is added to the batch and the mixture is stirred for another 5 minutes. After 24 hours, the binder dispersion is concentrated by distilling off the solvent ethanol. This gives a binder having a solids content of 60% by weight.

b) MTKZS 0.75

A mixture of 16.4 g of MTEOS and 4.8 g of TEOS is reacted with 14.2 g of silica sol Levasil® 300/30, which has previously been brought to a pH of 7 by means of concentrated hydrochloric acid, and 0.2 ml of concentrated hydrochloric acid. In parallel thereto, a mixture of 16.4 g of MTEOS and 4.8 g of TEOS is reacted with 19.88 g of a 50% strength, aqueous zirconium dispersion and 0.2 ml of concentrated hydrochloric acid. After 10 minutes, the two mixtures are combined. After 5 minutes, the combined mixture is admixed with a further silane mixture comprising 32.8 g of MTEOS and 9.6 g of TEOS and stirred for another 5 minutes. After 24 hours, the binder dispersion is concentrated by distilling off the solvent ethanol. This gives a binder having a solids content of 60% by weight.

c) MTKAlS 0.75

A mixture of 16.4 g of MTEOS and 4.8 g of TEOS is reacted with 14.2 g of silica sol Levasil® 300/30, which has previously been brought to a pH of 7 by means of concentrated hydrochloric acid, and 0.2 ml of concentrated hydrochloric acid. In parallel thereto, a mixture of 16.4 g of MTEOS and 4.8 g of TEOS is reacted with 12.2 g of a 15% Dispersal dispersion (1.83 g of Al₂O₃ in 10.37 g of water) and 0.2 ml of concentrated hydrochloric acid. After 10 minutes, the two mixtures are combined. After 5 minutes, the combined mixture is admixed with a further silane mixture comprising 32.8 g of MTEOS and 9.6 g of TEOS and stirred for another 5 minutes. After 24 hours, the binder dispersion is concentrated by distilling off the solvent ethanol. This gives a binder having a solids content of 60% by weight.

d) MTZAlS 0.75

A mixture of 16.4 g of MTEOS and 4.8 g of TEOS is reacted with 12.2 g of a 15% strength Dispersal dispersion (1.83 g of Al₂O₃ in 10.37 g of water) and 0.2 ml of concentrated hydrochloric acid. In parallel thereto, a mixture of 16.4 g of MTEOS and 4.8 g of TEOS is reacted with 19.88 g of a 50% strength zirconium oxide dispersion (9.94 g of IZCO in 9.94 g of water) and 0.2 ml of concentrated hydrochloric acid. After 10 minutes, the two mixtures are combined. After 5 minutes, the combined mixture is admixed with a further silane mixture comprising 32.8 g of MTEOS and 9.6 g of TEOS and stirred for another 5 minutes. After 24 hours, the binder dispersion is concentrated by distilling off the solvent ethanol. This gives a binder having a solids content of 60% by weight.

e) Z₅-MTKZS 0.75

A mixture of 16.4 g of MTEOS, 4.5 g of TEOS and 0.4 g of zirconium tetra-n-propoxide is reacted with 14.2 g of Levasil® 300/30, which has previously been brought to a pH of 7 by means of concentrated hydrochloric acid, and 0.2 ml of concentrated hydrochloric acid. In parallel thereto, a mixture of 16.4 g of MTEOS, 4.5 g of TEOS and 0.4 g of zirconium tetra-n-propoxide is reacted with 19.88 g of a 50% strength aqueous nanosize zirconium oxide dispersion and 0.2 ml of concentrated hydrochloric acid. After 10 minutes, the two mixtures are combined. After 5 minutes, the combined mixture is admixed with a further silane mixture comprising 32.8 g of MTEOS and 9.6 g of TEOS and stirred for another 5 minutes. After 24 hours, the binder dispersion is concentrated by distilling off the solvent ethanol. This gives a binder having a solids content of 60% by weight.

f) Z₅-MTKZS-PT 0.75

A mixture of 16.4 g of MTEOS, 4.5 g of TEOS and 0.4 g of zirconium tetra-n-propoxide is reacted with 14.2 g of Levasil® 300/30, which has previously been brought to a pH of 7 by means of concentrated hydrochloric acid, and 0.2 ml of concentrated hydrochloric acid. In parallel thereto, a mixture of 16.4 g of MTEOS, 4.5 g of TEOS and 0.4 g of zirconium tetra-n-propoxide is reacted with 19.88 g of a 50% strength aqueous nanosize zirconium oxide dispersion and 0.2 ml of concentrated hydrochloric acid. After 10 minutes, the two mixtures are combined. After 5 minutes, the combined mixture is admixed with a further silane mixture comprising 44.2 g of phenyltriethoxysilane and 9.6 g of TEOS and stirred for another 5 minutes. After 24 hours, the binder dispersion is concentrated by distilling off the solvent ethanol. This gives a binder having a solids content of 60% by weight.

B. Production of High-temperature-resistant Insulation Materials:

143 g of binder having a solids content of 60% by weight from A) are mixed with 50 g of hollow polystyrene microspheres (15-120 μm) and poured into a mold. Slow pyrolysis of the organic constituents at from 200 to 300° C. gives a fine-pored, high-temperature-resistant, solid insulation body. It is also possible to use vinyl acetate-ethylene copolymer powders, polyvinyl alcohol powders, waxes, wood powders, phenolic plastics powders, urea-formaldehyde resin powders, polyester resin powders, proteins, polysaccharides, silicone resin powders, hollow glass microspheres and mixtures thereof as space occupying constituents which form voids. Heating at about 1750° C. is subsequently carried out to produce the mullite/zirconium silicate phases.

100 g of binder having a solids content of 60% by weight from A) are admixed with 30 g of chemically or physically decomposable or oxidizable expandable components. In parallel to the curing process of the binder, the decomposition process with 3- to 10-fold volume expansion of the binder to form a fine-pored, solid, high-temperature-resistant insulating foam is initiated. As blowing agents, it is possible to use, for example, materials such as expandable graphite or substances such as melamines which liberate nitrogen.

1.-29. (canceled)

30. An insulation material, wherein the insulation material comprises an inorganic, porous matrix having additional pores therein and wherein the insulation material is based on a composition which comprises a) a sol comprising at least one of nanoparticles, polycondensates and precursors thereof as a binder and b) one or more solid pore formers giving rise to the additional pores.

31. The insulation material of claim 30, wherein the insulation material is obtainable by shaping the composition or applying the composition to a substrate and curing the composition.

32. The insulation material of claim 30, wherein an average pore diameter of the additional pores is greater than an average diameter of pores of the porous matrix.

33. The insulation material of claim 32, wherein the average pore diameter of the additional pores is at least 3 times larger than the average diameter of the pores of the porous matrix.

34. The insulation material of claim 33, wherein the average pore diameter of the additional pores is at least 5 times larger than the average diameter of the pores of the porous matrix.

35. The insulation material of claim 30, wherein the porous matrix comprises at least one of micropores and mesopores.

36. The insulation material of claim 32, wherein the average diameter of pores of the porous matrix is below 200 nm.

37. The insulation material of claim 33, wherein the average diameter of the pores of the porous matrix is below 50 nm.

38. The insulation material of claim 34, wherein the average diameter of the pores of the porous matrix is below 2 nm.

39. The insulation material of claim 30, wherein the additional pores comprise macropores.

40. The insulation material of claim 34, wherein the average diameter of the additional pores is at least 300 nm.

41. The insulation material of claim 36, wherein the average diameter of the additional pores is at least 0.5 μm.

42. The insulation material of claim 30, wherein the insulation material comprises at least 10% by volume of pores (matrix pores+additional pores), based on a total volume of the insulation material.

43. The insulation material of claim 30, wherein the composition further comprises organic compounds or organic groups which can be burned out to produce the inorganic matrix.

44. The insulation material of claim 30, wherein the nanoparticles comprise at least one metal oxide.

45. The insulation material of claim 44, wherein the nanoparticles comprise at least one of SiO₂, Al₂O₃, AlOOH, Ta₂O₅, TiO₂ and ZrO₂.

46. The insulation material of claim 30, wherein the nanoparticles comprise SiO₂.

47. The insulation material of claim 30, wherein the composition comprises a nanocomposite comprising nanoparticles which are surface-modified by at least one of an organic compound and a compound containing organic groups.

48. The insulation material of claim 47, wherein organic components of the nanocomposite have been burned out to form the matrix.

49. The insulation material of claim 47, wherein the nanoparticles are surface-modified by one or more compounds selected from hydrolyzable silanes having at least one non-hydrolyzable, organic group, carboxylic acids, anhydrides, amides, amine compounds, imines, β-diketones, amino acids and proteins.

50. The insulation material of claim 47, wherein the nanoparticles are surface-modified by one or more silanes of formula (I)
RₙSiX₄₋ₙ (I)
where the groups X are identical or different and are hydrolyzable groups or hydroxyl groups, the radicals R are identical or different and represent alkyl, alkenyl, alkynyl, aryl, aralkyl or alkylaryl, and n is 0, 1, 2 or 3.

51. The insulation material of claim 50, wherein n is greater than 0 for at least one of the one or more silanes of formula (I).

52. The insulation material of claim 50, wherein the one or more silanes of formula (I) comprise at least one silane wherein n is 1 or 2, and at least one silane of formula (II) has additionally been employed for surface-modifying the nanoparticles:
SiX₄ (II)
where the groups X are identical or different and are hydrolyzable groups or hydroxyl groups.

53. The insulation material of claim 30, wherein the composition further comprises at least one of a hydrolysis product and a condensation product of one or more hydrolyzable compounds of glass- or ceramic-forming metals as polycondensate or precursor thereof.

54. The insulation material of claim 53, wherein at least one of the one or more hydrolyzable compounds has at least one non-hydrolyzable substituent.

55. The insulation material of claim 53, wherein at least one of the one or more hydrolyzable compounds is selected from compounds of Si, Al, B, Sn, Ti, Zr, Mg, V and Zn.

56. The insulation material of claim 30, wherein the sol comprises a polycondensate or a precursor thereof and surface-modified nanoparticles.

57. The insulation material of claim 30, wherein the composition comprises at least one refractory component.

58. The insulation material of claim 30, wherein the one or more solid pore formers comprise hollow particles.

59. The insulation material of claim 30, wherein the one or more solid pore formers comprise particles which comprise at least one of a thermally decomposable and a vaporizable material.

60. The insulation material of claim 30, wherein the one or more solid pore formers comprise an intumescent agent.

61. The insulation material of claim 58, wherein the hollow particles comprise glass or a plastic material.

62. The insulation material of claim 59, wherein the particles comprise one or more of a metal nitrate, an organic salt, NH₄Cl, carbon black, flour, wood flour, a wax, a protein, a polysaccharide, a silicone resin and a plastic material.

63. The insulation material of claim 59, wherein the particles comprise hollow particles.

64. The insulation material of claim 30, wherein the composition further comprises at least one of an organic monomer, oligomer or polymer as additive for controlling at least one of a viscosity and a binding strength of a molding.

65. The insulation material of claim 30, wherein the material is in a form of a molded body.

66. The insulation material of claim 30, wherein the material is present as a coating on a substrate.

67. An insulation material, wherein the insulation material comprises an inorganic, porous matrix having additional pores therein and is based on a composition which comprises a) a sol comprising at least one of nanoparticles, polycondensates and precursors thereof as a binder and b) one or more solid pore formers giving rise to the additional pores, and wherein an average diameter of pores of the porous matrix is below 50 nm, an average diameter of the additional pores is at least 300 nm, and the insulation material comprises at least 12% by volume of pores (matrix pores+additional pores), based on a total volume of the insulation material.

68. A process for producing an insulation material comprising an inorganic, porous matrix, which process comprises shaping a composition or applying the composition to a substrate, the composition comprising a) a sol comprising at least one of nanoparticles, polycondensates and precursors thereof as a binder and b) one or more solid pore formers and curing the composition to form a porous matrix having therein additional pores formed by the one or more solid pore formers.

69. The process of claim 68, wherein the shaped or applied composition is heat-treated at a temperature of at least 40° C. to cure the composition.

70. The process of claim 68, wherein the shaped or applied composition is heat-treated in at least two stages having different temperatures.

71. The process of claim 68, wherein the composition is heat-treated at a temperature of at least 100° C. to effect intermediate curing or curing.

72. The process of claim 71, wherein the composition is heat-treated at a temperature of at least 150° C.

73. The process of claim 68, wherein the composition is cured at a temperature of at least 300° C.

74. The process of claim 73, wherein the composition is cured at a temperature of at least 350° C.

75. A method of at least one of insulating an object against heat or cold and protecting the object from fire, wherein the method comprises employing the insulating material of claim 30 to insulate or protect the object.

76. A method of protecting a heat-sensitive component from heat, wherein the method comprises encapsulating the heat-sensitive component with the insulating material of claim 30.
